(19) United States
(12) Patent Application Publication
(10) Pub. No.: US 2013/0095254 A1
(43) Pub. Date: Apr. 18, 2013

(54) IMAGE-RECORDING COMPOSITION, IMAGE-RECORDING APPARATUS, AND IMAGE-RECORDING METHOD

(71) Applicant: Kentaro AGEISHI, Kanagawa (JP)

(72) Inventor: Kentaro AGEISHI, Kanagawa (JP)

(73) Assignee: FUJI XEROX CO., LTD., Tokyo (JP)

(21) Appl. No.: 13/492,259

(22) Filed: Jun. 8, 2012

(30) Foreign Application Priority Data
Oct. 14, 2011 (JP) 2011-227264

(51) Int. Cl. C08L 75/04; B05D 3/02; B05D 3/06; B05C 9/14; B05D 5/00

(52) U.S. Cl. 427/552; 525/100; 525/92 C; 525/123; 118/58; 118/641; 427/256; 427/558

(57) ABSTRACT

An image-recording composition contains absorbent particles; a curable material curable in response to ultraviolet radiation, an electron beam, or heat; and a viscocontroller that increases the viscosity of the image-recording composition with increasing temperature.

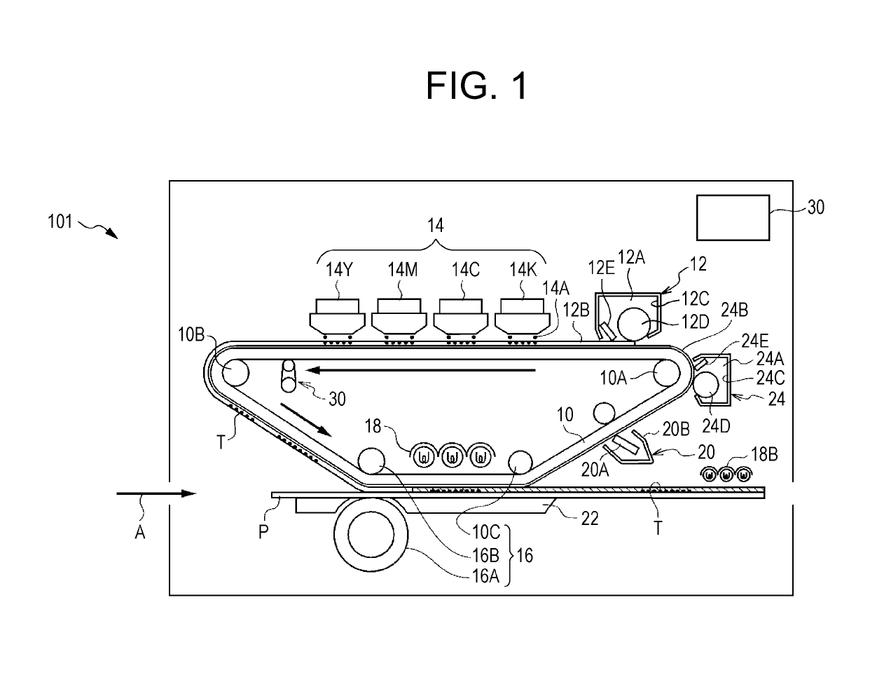

### CROSS-REFERENCE TO RELATED APPLICATIONS

This application is based on and claims priority under 35 USC 119 from Japanese Patent Application No. 2011-227264 filed Oct. 14, 2011.

### BACKGROUND

(i) Technical Field

The present invention relates to image-recording compositions, image-recording apparatuses, and image-recording methods.

(ii) Related Art

Inkjet image-recording methods have been attempted in which an image is formed on an intermediate transfer member by an inkjet process and is transferred to a recording medium to form a final image.

### SUMMARY

According to an aspect of the invention, there is provided an image-recording composition containing absorbent particles; a curable material curable in response to ultraviolet radiation, an electron beam, or heat; and a viscocontroller that increases the viscosity of the image-recording composition with increasing temperature.

### BRIEF DESCRIPTION OF THE DRAWINGS

Exemplary embodiments of the present invention will be described in detail based on the following FIGURE, wherein:

The FIGURE is a schematic view illustrating an example of a recording apparatus according to an exemplary embodiment.

### DETAILED DESCRIPTION

An image-recording composition, image-recording apparatus, and image-recording method according to an exemplary embodiment of the present invention will now be described in detail.

### Image-Recording Composition

The image-recording composition according to this exemplary embodiment contains absorbent particles, a curable material curable in response to a stimulus, and a viscocontroller that increases the viscosity of the image-recording composition with increasing temperature.

An image-recording composition is supplied to an intermediate transfer member to form a curable layer. A liquid such as ink is then ejected as droplets onto the curable layer to form an image. After the image is formed, the curable layer is transferred from the intermediate transfer member to a recording medium and is cured by applying a stimulus to fix the image on the recording medium.

However, the droplets ejected onto the curable layer may cause swelling and viscosity variation as they are absorbed by absorbent particles in the curable layer, thus distorting the image.

In addition, the viscosity difference between parts of the curable layer where the droplets are deposited (image parts) and parts of the curable layer where no droplets are deposited (non-image parts) cause swelling of the image parts. This swelling may result in surface irregularities, image degradation, and thickness variations between printed and unprinted parts in the image transferred to the recording medium.

In contrast, the image-recording composition according to this exemplary embodiment contains a viscocontroller that increases the viscosity of the image-recording composition with increasing temperature. After the image-recording composition is supplied to the intermediate transfer member to form a curable layer and droplets are ejected onto the curable layer, the temperature thereof is increased to increase the viscosity of the image-recording composition. The viscocontroller then thickens the non-image parts and may thus inhibit the flow of the non-image parts and the secondary aggregation of the absorbent particles. This may reduce distortion due to swelling, aggregation, and thickness variation of the absorbent particles forming the image parts and may also reduce distortion due to viscosity variation of the absorbent particles forming the image parts.

In addition, the viscosity difference between the image parts and the non-image parts may be reduced, and therefore swelling of the image parts may be inhibited. This may reduce bleeding and surface irregularities due to aggregation of the absorbent particles in the image transferred to the recording medium.

The addition of a viscocontroller to a liquid such as ink has been attempted in the related art, although it is intended to thicken image parts. In contrast, this exemplary embodiment may thicken non-image parts to reduce image distortion, depressions, and thickness deviation and swelling of the image parts.

Image distortion and swelling of the image parts occur more noticeably during the period of time after droplets are ejected onto the curable layer and before the curable layer is cured by applying a stimulus. Accordingly, the temperature of the curable layer formed using the image-recording composition according to this exemplary embodiment may be increased after droplets are ejected onto the curable layer and before the curable layer is transferred to a recording medium.

In-Plane Variation of Curable Layer after Cure

The curable layer formed on the intermediate transfer member using the image-recording composition according to this exemplary embodiment preferably has a coating thickness of 1 to 100 μm, more preferably 5 to 50 μm. As noted above, the use of the image-recording composition according to this exemplary embodiment may inhibit swelling of the image parts. The thickness of the curable layer after cure may be 5 to 50 μm, and the in-plane variation of the curable layer after cure may be 10% or less.

The thickness of the curable layer after cure is determined from the step height between the non-image parts and the image parts measured over a traverse length of 4 mm using a stylus surface roughness meter (e.g., SURFCOM 590A from Tokyo Seimitsu Co., Ltd.).

The in-plane variation (%) of the curable layer after cure is determined by measuring the surface roughness of the image parts and the non-image parts using the surface roughness meter and calculating the ten-point average roughness Rz (μm).

Next, the components of the image-recording composition according to this exemplary embodiment will be described in detail.

### Viscocontroller

The viscocontroller may be any material that increases the viscosity of the image-recording composition with increasing temperature.

Examples of viscocontrollers include alkylene oxide adduct surfactants (such as polyethylene glycol diacrylate crosslinked polymer), crosslinked polyacrylic acid salts (such as saponified polyacrylonitrile), polyvinylpyrrolidone, polyacrylamide-modified vinyl polymers, polyvinyl alcohol (such as crosslinked polyvinyl alcohol and saponified acrylic acid-vinyl acetate copolymer), cellulose derivatives (such as crosslinked carboxymethylcellulose, acrylonitrile-cellulose graft copolymer, and cellulose-styrenesulfonic acid graft copolymer), polysaccharides (such as polysaccharide polymers), and starch derivatives (such as starch-acrylic acid graft copolymer, starch-acrylonitrile graft copolymer, starch-styrenesulfonic acid graft copolymer, and starch-vinylsulfonic acid graft copolymer).

Associative viscocontrollers are capable of molecular association with water-soluble polymers containing discontinuous water-unsaturated and hydrophobic groups. These viscocontrollers cause thickening through interaction with dispersed particles, such as those in latex, when associated with or adsorbed on the surfaces thereof. Examples of associative viscocontrollers include celluloses, polyacrylate-based or ethylene-oxide-based urethane copolymers, and anionic acrylate copolymers.

Examples of polymer gel formation include formation of a composite gel by chemically modifying a polysaccharide gel, such as starch or agarose, or a protein or polypeptide gel, such as gelatin. Examples of gel formation by polymerization reaction include formation of a crosslinked polymer by reaction of a polyanion or polycation with a crosslinking agent and copolymerization of an electrolyte monomer (monomer containing a hydrophilic group such as an amide, carboxyl, hydroxyl, sulfonic acid, phosphoric acid, tertiary amino, or quaternary amino group, or another dissociative group) with a crosslinking monomer. Other examples include hydrolysis of polyacrylamide gel and formation of an anionic gel or polymer electrolyte gel by facilitating hydrolysis through alkali treatment to introduce a dissociative group into the polymer chain, thereby forming saponified polyvinyl acetate, saponified methyl acrylate-vinyl acetate copolymer, or saponified acrylonitrile-vinyl acetate copolymer.

Other examples of viscocontrollers include vinyl carboxylic acid esters of alkylene oxide adducts containing a nitrogen-containing ring (such as a morpholine, aziridine, pyrrolidine, pyrroline, pyridine, or piperidine ring) and adducts of morpholine with a water-soluble vinyl polymer or ethylene oxide-propylene oxide copolymer. Also available are ionic monomers having ionic gel swelling properties, such as carboxylic acids, sulfonic acids, and phosphoric acids, and monomers having one or more ultraviolet-curable sites containing an acrylate or methacrylate group, including cationic monomers such as tertiary and quaternary amines.

Also available are natural viscocontrollers such as alginates, polysaccharides, starch, carboxymethylcellulose, and guar gum powder.

For cationic resins, a mixture of a copolymer of a polyalkylene amine such as polyethylene amine or polypropylene amine and an acrylic resin monomer having a tertiary amine or quaternary ammonium salt (such as acrylamide-diallylamine copolymer or epichlorohydrin-dimethylamine adduct) and a material capable of thickening through ionic bonding with an acrylic or methacrylic resin may be used.

Also available are N-isopropylacrylamide, polyvinyl methyl ether, polyethylene oxide, hydroxymethylcellulose, polyoxyethylene-polyoxypropylene-polyoxyethylene triblock copolymer, and water-based polyurethane.

Particularly preferred are viscocontrollers having a reactive group in the molecule thereof, for example, viscocontrollers having at least one group selected from the group consisting of acrylate and methacrylate groups. A viscocontroller having a reactive group (particularly, a radical-polymerizable group) may contribute to curing as well as thickening of the image-recording composition. The viscocontroller may also contribute to image durability because it may remain in a recording medium and maintain its viscosity after ejection and transfer are complete.

The amount of viscocontroller added to the image-recording composition is preferably 0.1% by mass or more, more preferably 3% by mass or more. If the viscocontroller has no reactive group in the molecule thereof, the amount of viscocontroller added is preferably 30% by mass or less, more preferably 10% by mass or less. If the viscocontroller has a reactive group in the molecule thereof, the amount of viscocontroller added may be 50% by mass or less.

### Absorbent Particles

The image-recording composition contains absorbent particles that absorb ink as a material for fixing the colorant contained in the ink. The absorbent particles contain an absorbent material as a major component. As used herein, the term “major component” refers to a component contained in an amount of 50% by mass or more of the total amount. The term “absorbent material” refers to a material whose weight increases by 5% or more after a mixture of the material with ink at a weight ratio of 30:100 is stirred for 24 hours and is then filtered to remove the absorbent material from the mixture.

The absorbent material is selected from, for example, resins (hereinafter also referred to as “absorbent resins”) and inorganic particles having surfaces with ink affinity (such as silica, alumina, and zeolite), depending on the ink used.

Specifically, if the ink used is water-based, the absorbent material may be a water-absorbing resin material. If the ink used is oil-based, the absorbent material may be an oil-absorbing material.

Examples of water-absorbing materials include polyacrylic acid and salts thereof; polymethacrylic acid and salts thereof; (meth)acrylate-(meth)acrylic acid copolymers and salts thereof; styrene-(meth)acrylic acid copolymers and salts thereof; styrene-(meth)acrylate-(meth)acrylic acid copolymers and salts thereof; styrene-(meth)acrylate-carboxylic acid copolymers and esters, having a salt structure thereof, of an alcohol substituted with an aliphatic or aromatic group and (meth)acrylic acid; (meth)acrylate-carboxylic acid copolymers and esters, having a salt structure thereof, of an alcohol substituted with an aliphatic or aromatic group and (meth)acrylic acid; ethylene-(meth)acrylic acid copolymers; butadiene-(meth)acrylate-(meth)acrylic acid copolymers and salts thereof; butadiene-(meth)acrylate-carboxylic acid copolymers and esters, having a salt structure thereof, of an alcohol substituted with an aliphatic or aromatic group and (meth)acrylic acid; polymaleic acid and salts thereof; styrene-maleic acid copolymer and salts thereof; the above resins modified with a sulfonic acid; and the above resins modified with a phosphoric acid. Particularly preferred are polyacrylic acid and salts thereof; styrene-(meth)acrylic acid copolymers and salts thereof; styrene-(meth)acrylate-(meth)acrylic acid copolymers and salts thereof; styrene-(meth)acrylate-carboxylic acid copolymers and esters, having a salt structure thereof, of an alcohol substituted with an aliphatic or aromatic group and (meth)acrylic acid; and (meth)acrylate-(meth)acrylic acid copolymers and salts thereof. These resins may be crosslinked with a material having multiple reactive groups such as divinylbenzene.

Examples of oil-absorbing materials include low-molecular-weight gelling agents such as hydroxystearic acid, cholesterol derivatives, and benzylidene sorbitol and polymer gelling agents such as polynorbornene, polystyrene, polypropylene, styrene-butadiene copolymer, and various rosins. Particularly preferred are polynorbornene, polypropylene, and rosins.

Other examples of absorbent particles include acidic compounds, such as alkylamine compounds, hydroxy compounds, sulfonic acids, phosphoric acid compounds, and tertiary and quaternary amine salts, that are ionically bonded to (meth)acrylic acid, (meth)acrylamide, or polyvinyl alcohol.

The absorbent particles may be solid particles or, as in an emulsion, liquid particles dispersed in the curable layer. The absorbent particles may be semi-dissolved (for example, some crosslinks in the polymer are cleaved to stretch the molecular chains thereof) or may be partially dissolved in and swelled with the curable medium.

The particle size (volume average particle size) of the absorbent particles is preferably 0.05 to 25 μm, more preferably 0.05 to 5 μm.

The specific gravity of the absorbent particles may be lower than that of the curable material contained in the image-recording composition. The content of the absorbent particles in the image-recording composition is preferably 1% to 60% by mass, more preferably 10% to 50% by mass, still more preferably 20% to 40% by mass.

If the absorbent particles are resin particles containing an absorbent material, the resin particles may be prepared by, for example, pulverizing a resin or monomer containing the absorbent material by ball milling.

### Curable Material

Examples of curable materials include, but not limited to, ultraviolet-curable materials, electron-beam-curable materials, thermosetting materials, and curable materials curable with other stimuli such as moisture and oxygen. As used herein, the term “curable material” refers to a material that cures irreversibly. Particularly preferred are ultraviolet-curable materials that react at a particular wavelength such as the wavelength of a light-emitting diode (LED). Such a material may be used for shape retention of the image parts, increased curing rate, reduced oxygen inhibition in the curable layer laminated on the recording medium by contact between the intermediate transfer member and the recording medium when the curable layer is transferred from the intermediate transfer member to the recording medium, and high-speed transfer recording with improved reaction rate.

Examples of ultraviolet-curable resins prepared by curing ultraviolet-curable materials include acrylic resins, methacrylic resins, urethane resins, polyester resins, maleimide resins, epoxy resins, oxetane resins, polyether resins, and polyvinyl ether resins. Ultraviolet-curable materials contain at least one of ultraviolet-curable monomers, ultraviolet-curable macromers, ultraviolet-curable oligomers, and ultraviolet-curable prepolymers. The image-recording composition may optionally contain an ultraviolet polymerization initiator for facilitating ultraviolet curing reaction and other additives for facilitating ultraviolet curing reaction, including reaction aids, polymerization accelerators, and dispersants.

Examples of ultraviolet-curable monomers include radical-polymerizable materials having one or more reactive groups such as acrylic acid esters of alcohols, polyalcohols, and amino alcohols, methacrylic acid esters of alcohols and polyalcohols, acrylic aliphatic amides, acrylic alicyclic amides, and acrylic aromatic amides; and cationically curable materials having one or more reactive groups such as epoxy monomers, oxetane monomers, and vinyl ether monomers. Examples of ultraviolet-curable macromers, ultraviolet-curable oligomers, and ultraviolet-curable prepolymers include polymers of the above monomers and radical-polymerizable materials having an epoxy, urethane, polyester, or polyether backbone to which an acryloyl or methacryloyl group is added, including epoxy acrylates, urethane acrylates, polyester acrylates, polyether acrylates, urethane methacrylates, and polyester methacrylates.

Examples of electron-beam-curable resins prepared by curing electron-beam-curable materials include acrylic resins, methacrylic resins, urethane resins, polyester resins, polyether resins, and silicone resins. Electron-beam-curable materials contain at least one of electron-beam-curable monomers, electron-beam-curable macromers, electron-beam-curable oligomers, and electron-beam-curable prepolymers.

Examples of electron-beam-curable monomers, electron-beam-curable macromers, electron-beam-curable oligomers, and electron-beam-curable prepolymers include the same materials as ultraviolet-curable materials.

Examples of thermosetting resins prepared by curing thermosetting materials include epoxy resins, polyester resins, phenolic resins, melamine resins, urea resins, and alkyd resins. Thermosetting materials contain at least one of thermosetting monomers, thermosetting macromers, thermosetting oligomers, and thermosetting prepolymers. The image-recording composition may contain a curing agent for polymerization and a thermal polymerization initiator for facilitating thermal curing reaction.

Examples of thermosetting monomers include phenol, formaldehyde, bisphenol A, epichlorohydrin, cyanuramide, urea, polyalcohols such as glycerol, and acids such as phthalic anhydride, maleic anhydride, and adipic acid. Examples of thermosetting macromers, thermosetting oligomers, and thermosetting prepolymers include polymers of the above monomers, urethane prepolymers, epoxy prepolymers, and polyester prepolymers.

The curable material, as listed above, may be any material that is curable with external energy such as ultraviolet radiation, electron beam, or heat (for example, curable by polymerization reaction).

The curable material may contain a curable prepolymer having a molecular weight of 1,000 to 50,000 for more efficient thickening of the image-recording composition through interaction with the viscocontroller.

### Surfactant

The image-recording composition according to this exemplary embodiment may contain a surfactant.

Examples of surfactants for the image-recording composition according to this exemplary embodiment include anionic surfactants, nonionic surfactants, cationic surfactants, and amphoteric surfactants. In particular, anionic surfactants and nonionic surfactants are preferred, and nonionic surfactants are more preferred because they do not inhibit the effect of the viscocontroller.

Examples of anionic surfactants include alkylbenzenesulfonic acid salts, alkylphenylsulfonic acid salts, alkylnaphthalenesulfonic acid salts, higher fatty acid salts, sulfuric acid ester salts of higher fatty acid esters, sulfonic acid ester salts of higher fatty acid esters, sulfuric acid ester salts and sulfonic acid salts of higher alcohol ethers, higher alkyl sulfosuccinic acid salts, polyoxyethylene alkyl ether carboxylic acid salts, polyoxyethylene alkyl ether sulfuric acid salts, alkyl phosphoric acid salts, and polyoxyethylene alkyl ether phosphoric acid salts. Particularly preferred are dodecylbenzenesulfonic acid salts, isopropylnaphthalenesulfonic acid salts, monobutylphenylphenolmonosulfonic acid salts, monobutylbiphenylsulfonic acid salts, and dibutylphenylphenoldisulfonic acid salts.

Examples of nonionic surfactants include polyoxyethylene alkyl ethers, polyoxyethylene alkylphenyl ethers, polyoxyethylene fatty acid esters, sorbitan fatty acid esters, polyoxyethylene sorbitan fatty acid esters, polyoxyethylene sorbitol fatty acid esters, glycerol fatty acid esters, polyoxyethylene glycerol fatty acid esters, polyglycerol fatty acid esters, sucrose fatty acid esters, polyoxyethylene alkylamines, polyoxyethylene fatty acid amides, alkylalkanolamides, polyethylene glycol-polypropylene glycol block copolymer, acetylene glycol, and polyoxyethylene adducts of acetylene glycol. Particularly preferred are polyoxyethylene nonylphenyl ether, polyoxyethylene octylphenyl ether, polyoxyethylene dodecylphenyl ether, polyoxyethylene alkyl ethers, polyoxyethylene fatty acid esters, sorbitan fatty acid esters, polyoxyethylene sorbitan fatty acid esters, fatty acid alkylolamides, polyethylene glycol-polypropylene glycol block copolymer, acetylene glycol, and polyoxyethylene adducts of acetylene glycol having a polydimethylsiloxane side chain, particularly those having one or more ultraviolet-curable acrylic or methacrylic residue in a side chain thereof.

Also available are (meth)acrylic acid-modified silicone surfactants such as oxyethylene adduct of polysiloxane; fluorinated surfactants such as perfluoroalkylcarboxylic acid salts, perfluoroalkylsulfonic acid salts, and oxyethylene perfluoroalkyl ethers; and biosurfactants such as spiculisporic acid, rhamnolipids, and lysolecithins.

These surfactants may be used alone or as a mixture. For higher solubility, an amphiphilic surfactant having a hydrophile-lipophile balance (hereinafter referred to as “HLB”) of 8 to 18 may be used.

The HLB is defined by the following equation (Griffin's equation):

HLB=20×(total formula weight of hydrophilic portion/molecular weight)

To achieve a higher miscibility between the absorbent particles and the monomer by HLB control with a nonionic surfactant, the surfactant may be modified with a silicone component. Specifically, the silicone component may be one that has a side chain thereof modified with a dimethylsiloxane derivative, that contains a polypropylene glycol (PPG) or polyethylene oxide (PEO) component and an acrylic residue, and that has photoreactivity and a certain level of viscosity. The surfactant may be modified with the silicone component by a known method.

Examples of surfactants modified with silicone components include dimethylsilicone polymers (HLB=9 to 18) having at least one of polyethylene glycol and polypropylene glycol as a side chain.

Surfactants having an ultraviolet-curable group may be used. Examples of ultraviolet-curable groups include the functional groups of the monomers listed above as ultraviolet-curable monomers.

The content of the surfactant in the image-recording composition according to this exemplary embodiment is preferably 0.1% to 30% by mass, more preferably 0.5% to 10% by mass.

### Other Materials Contained in Image-Recording Composition

The image-recording composition according to this exemplary embodiment may further contain the following materials.

The image-recording composition according to this exemplary embodiment preferably contains at least one hydrophobic monomer having a functional group and having a solubility parameter (SP) of 7 to 9.6, more preferably 8 to 9.6.

Examples of monomers having an SP of 9.6 or less include neopentyl glycol diacrylate and derivatives thereof, hexanediol diacrylate, tripropylene glycol diacrylate, polyfunctionalized dipentaerythritols, various ethylene-oxide-modified phenoxy acrylates, alkoxyalkyl acrylates, cyclohexyl acrylate, and dicyclopentadiene acrylate.

The total content of the hydrophobic monomer having the above SP in the image-recording composition is preferably 1% to 30% by mass, more preferably 5% to 30% by mass.

This hydrophobic monomer may lower the viscosity of the image-recording composition according to this exemplary embodiment. In addition, the hydrophobic monomer may reduce absorption inhibition in an image region due to ink ejected onto the curable layer and variations in image quality and density.

A mixture of more than one hydrophobic monomers having SPs within the above range may be used. These hydrophobic monomers are preferably monofunctional, difunctional, or trifunctional, more preferably monofunctional or difunctional.

Examples of functional groups of the hydrophobic monomers include long-chain alkoxy groups having a functionality such as alkyl, cycloalkyl, branched alkoxy, cyclohexyl, or a dimethylsiloxane derivative, specifically, lauryl, dodecyl, hexamethylene, pentaerythritol derivatives, trimethylolpropane derivatives, cyclohexyl derivatives, butanediol, and low-molecular-weight polyethylene glycol (molecular weight: 200) derivatives.

Particularly preferred are lauryl and dodecyl.

The hydrophobic monomer preferably has an alkylene oxide structure, more preferably at least one of propylene oxide structure and ethylene oxide structure, still more preferably both of propylene oxide structure and ethylene oxide structure.

Examples of hydrophobic monomers having a functional group and having an SP of 9.6 or less are listed below. The numbers in parentheses are SPs. The SPs are calculated from the structural formulas of the compounds by Fedors' method.

Examples of hydrophobic monomers include monofunctional hydrophobic monomers such as tetrahydrofurfuryl acrylate (THFA) (9.6), cyclohexyl acrylate (CHA) (9.6), isobornyl methacrylate (IBXMA) (9.6), ethylhexyl acrylate (HA) (8.9), dodecyl methacrylate (DMA) (8.8), lauryl acrylate (LA) (8.7), and phenoxy (ethylene glycol) n=4 or more acrylate (9.4); difunctional hydrophobic monomers such as ethoxy ethylene oxide acrylate (8.3), dipropylene glycol (1000 or more) diacrylate (8.6), 1,6-hexanediol acrylate (9.6), diacrylates having a polyol main chain (PEG200) (8.8), PEG400 (8.5), PEG600 (8.4) (available from DAICEL-CYTEC Company Ltd.), neopentyl glycol diacrylate (9.4), and glycidol dimethacrylate (9.1); and various polyether-modified acrylates and alicyclic acrylates such as methoxy polyethylene glycol acrylate (n=8) (9.3), pentamethylpiperidyl methacrylate (8.7), tetrahydrofurfuryl acrylate (9.2), dicyclopentanyl acrylate (9.3), dipropylene or tripropylene glycol acrylate (9 to 9.5), (vinyloxyethoxy)ethyl acrylate (8.7) and methacrylate (8.7), ethylene-oxide-modified polypropylene glycol dimethacrylate (8.2), neopentyl glycol diacrylate (9.4), polypropylene glycol (8.2), glycerol propoxy triacrylate (9.2), and trimethylolethane triacrylate (9.1).

The image-recording composition may optionally contain a polymerization initiator and other additives for facilitating polymerization reaction, including reaction aids and polymerization accelerators.

Examples of ultraviolet polymerization initiators for radical ultraviolet curing reaction of the image-recording composition include benzophenone, thioxanthones, benzyl dimethyl ketal, α-hydroxyketones, α-hydroxyalkylphenones, α-aminoketones, α-aminoalkylphenones, monoacyl phosphine oxide, bisacyl phosphine oxide, hydroxybenzophenone, aminobenzophenone, titanocenes, oxime esters, and oxyphenylacetic acid esters.

Examples of ultraviolet polymerization initiators for cationic ultraviolet curing reaction of the image-recording composition include arylsulfonium salts, aryldiazonium salts, diaryliodonium salts, triarylsulfonium salts, arene-ion complex derivatives, and triazine initiators.

The image-recording composition according to this exemplary embodiment may further contain a wax or rubber-like material.

The image-recording composition according to this exemplary embodiment may further contain a component that fixes an ink component on or in the curable layer (hereinafter also referred to as “fixing component”).

Examples of fixing components include, but not limited to, components that adsorb an ink component (such as a colorant) and components that aggregate or thicken an ink component (such as a colorant).

The image-recording composition may contain water or an organic solvent for dissolving or dispersing the components that contribute to curing reaction.

The image-recording composition may contain various colorants for color control of the curable layer.

The image-recording composition may contain a thermoplastic resin for purposes such as viscosity adjustment. Examples of thermoplastic resins include acrylic resins, polyester resins, polycarbonate resins, polyurethane resins, polyether resins, polyethylene resins, polypropylene resins, polystyrene and copolymers thereof with acrylic monomers, and blends thereof.

The image-recording composition according to this exemplary embodiment has a surface tension of, for example, 20 to 50 mN/m.

The image-recording composition may be of low or no volatility at room temperature (25° C.). As used herein, the term “low volatility” refers to having a boiling point of 200° C. or higher under atmospheric pressure. The term “no volatility” refers to having a boiling point of 300° C. or higher under atmospheric pressure.

### Ink

Next, the ink used in this exemplary embodiment will be described in detail. The ink corresponds to a liquid ejected onto the curable layer by the recording apparatus according to this exemplary embodiment.

The ink may be either water-based or oil-based. In particular, a water-based ink may be used for environmental friendliness. The water-based ink (hereinafter simply referred to as “ink”) contains a recording material and an ink solvent (such as water or water-soluble organic solvent). The ink may optionally contain other additives such as humectants, pigments, surfactants, preservatives, and thickeners.

The recording material will be described first. The recording material is typically a colorant. The colorant may be either a dye or a pigment, preferably a pigment. The colorant may be a known material.

Other examples of recording materials include dyes such as hydrophilic anionic dyes, direct dyes, cationic dyes, reactive dyes, polymeric dyes, and oil-soluble dyes; wax powders, resin powders, and emulsions colored with dyes; fluorescent dyes and pigments; infrared absorbers; ultraviolet absorbers; magnetic materials such as ferromagnetic materials, typically ferrite and magnetite; semiconductors and photocatalysts such as titanium oxide and zinc oxide; and other organic and inorganic electronic material particles.

The content (concentration) of the recording material is, for example, 5% to 30% by mass of the amount of ink.

The volume average particle size of the recording material is, for example, 10 to 1,000 nm. The term “volume average particle size” refers to the particle size of the recording material itself or, if additives such as dispersants are deposited thereon, the particle size of the recording material including the deposit. The volume average particle size is measured using a Microtrac UPA 9340 particle size analyzer (available from Leeds & Northrup Co.). The measurement is performed using 4 ml of ink placed in a measurement cell according to a predetermined measurement procedure. The viscosity input in the measurement is the viscosity of the ink, and the density of the dispersed particles input in the measurement is the density of the recording material.

Next, the water-soluble organic solvent will be described. Examples of water-soluble organic solvents include polyalcohols, polyalcohol derivatives, nitrogen-containing solvents, alcohols, and sulfur-containing solvents.

The image-recording composition may contain at least one water-soluble organic solvent. The content of the water-soluble organic solvent is, for example, 1% to 70% by mass.

Next, the water will be described. To ensure that the water contains no impurities, ion exchange water, ultrapure water, distilled water, or ultrafiltration water may be used.

Next, other additives will be described. The ink may contain a surfactant.

Examples of surfactants include various anionic surfactants, nonionic surfactants, cationic surfactants, and amphoteric surfactants, preferably anionic surfactants and nonionic surfactants.

The ink may further contain permeation promoters for permeability control; additives for improving properties such as ink ejection properties, such as polyethyleneimine, polyamines, polyvinylpyrrolidone, polyethylene glycol, ethylcellulose, and carboxymethylcellulose; alkali metal compounds for conductivity or pH control, such as potassium hydroxide, sodium hydroxide, and lithium hydroxide; and other optional additives such as pH buffers, antioxidants, fungicides, viscosity modifiers, conductive agents, ultraviolet absorbers, and chelating agents.

Next, the properties of the ink will be described. The ink has a surface tension of, for example, 20 to 45 mN/m.

The surface tension is measured using a Wilhelmy plate tensiometer (available from Kyowa Interface Science Co., Ltd.) at 23° C. and 55% RH.

The ink has a viscosity of, for example, 1.5 to 30 mPa·s. The viscosity is measured using Rheomat 115 (available from Contraves AG) at a measurement temperature of 23° C. and a shear rate of 1,400 s⁻¹.

The composition of the ink is not limited to those shown above. In addition to the recording material, the ink may contain functional materials such as liquid crystal materials and electronic materials.

### Recording Apparatus and Recording Method

The recording apparatus according to this exemplary embodiment includes an intermediate transfer member; a supply device that supplies the image-recording composition described above to the intermediate transfer member to form a curable layer; an ejecting device that ejects droplets containing an aqueous solvent onto the curable layer formed on the intermediate transfer member; a transfer device that transfers the curable layer having the droplets deposited thereon from the intermediate transfer member to a recording medium; a temperature-increasing device that increases the temperature of the curable layer after the droplets are ejected onto the curable layer by the ejecting device and before the curable layer is transferred to the recording medium by the transfer device; and a stimulus-applying device that applies a stimulus to the curable layer.

The recording method according to this exemplary embodiment includes a step of supplying the image-recording composition described above to an intermediate transfer member to form a curable layer; a step of ejecting droplets containing an aqueous solvent onto the curable layer formed on the intermediate transfer member; a step of transferring the curable layer having the droplets deposited thereon from the intermediate transfer member to a recording medium; a step of increasing the temperature of the curable layer after the droplets are ejected onto the curable layer in the ejecting step and before the curable layer is transferred to the recording medium in the transfer step; and a step of applying a stimulus to the curable layer.

The temperature-increasing device may heat at least part of the intermediate transfer member to a temperature of 30° C. to 100° C. or about 30° C. to about 100° C. to increase the medium temperature of the curable layer on the intermediate transfer member.

The temperature-increasing device may heat the intermediate transfer member from the surface of the intermediate transfer member opposite the surface on which the curable layer is formed.

The viscosity of the image-recording composition before the temperature thereof is increased may be 3,000 mPa·s or less. The viscosity increased after the temperature thereof is increased may be 1,500 to 50,000 mPa·s and may be higher than the viscosity before the temperature thereof is increased.

The viscosity of the image-recording composition may be higher than that of the ink.

The viscosity is measured by the following procedure, by which the viscosities shown herein are measured. The viscosity (mPa·s) is measured using a TV-22 viscometer (available from Toki Sangyo Co., Ltd.) at shear rates of 2.25 to 750 (1/s) and a temperature of 15° C. The viscosities shown herein are those at a shear rate of 10 s⁻¹.

The structure of an image-forming apparatus 101 according to this exemplary embodiment will now be described with reference to the drawings. The FIGURE is a schematic view illustrating the structure of the image-forming apparatus 101 according to this exemplary embodiment.

Referring to the FIGURE, the image-forming apparatus 101 according to this exemplary embodiment includes a transfer belt 10 as an example of a member on which a layer of the image-recording composition (hereinafter referred to as “curable layer”) 12B, described later, is formed, and also includes a transport unit (not shown) that transports a recording medium P to which the curable layer 12B is transferred from the transfer belt 10.

The transport unit includes, for example, a transport belt or drum that transports the recording medium P by, for example, electrostatically attracting the recording medium P to the circumferential surface thereof and a pair of transport rollers that hold and transport the recording medium P. The recording medium P is transported in the direction of arrow A in the FIGURE.

The recording medium P to which the curable layer 12B is transferred is, for example, paper (such as plain paper, inkjet coated paper, art paper, or synthetic paper). The recording medium P, however, is not limited to paper, but may be any medium to which the curable layer 12B can be transferred, for example, a plastic film (such as a polypropylene or polyethylene terephthalate film).

The transfer belt 10 is an annular seamless endless belt. The transfer belt 10, however, may be a seamed belt instead.

Tension rollers 16B, 10C, 10A, and 10B are disposed on the inner circumferential side of the transfer belt 10 as an example of members around which the transfer belt 10 is entrained. The tension roller 16B is disposed upstream (in the FIGURE, to the left) of a curing device 18, described later, in the transport direction of the recording medium P. The tension roller 16C is disposed downstream (in the FIGURE, to the right) of the tension roller 16B and the curing device 18 in the transport direction of the recording medium P.

The tension roller 10A is disposed downstream (in the FIGURE, to the right) of the tension roller 10C in the transport direction of the recording medium P and on the side of the recording medium P facing away from (in the FIGURE, above) a platen 22, described later. The tension roller 10B is disposed upstream (in the FIGURE, to the left) of the tension roller 16B in the transport direction of the recording medium P and on the side of the recording medium P facing away from (in the FIGURE, above) the platen 22.

The width (axial length) of the transfer belt 10 is larger than or equal to the width of the recording medium P.

The transfer belt 10 may be formed of a known material commonly used for transfer belts. Examples of materials for the transfer belt 10 include various resins (such as polyimide, polyamideimide, polyester, polyurethane, polyamide, polyethersulfone, polyarylate, polycarbonate, and fluorocarbon resins); various rubber (such as nitrile rubber, ethylene propylene rubber, chloroprene rubber, isoprene rubber, styrene rubber, butadiene rubber, butyl rubber, chlorosulfonated polyethylene, urethane rubber, epichlorohydrin rubber, acrylic rubber, silicone rubber, and fluorocarbon rubber); and metals such as stainless steel. The transfer belt 10 may have a monolayer structure or a multilayer structure of the same or different materials.

The transfer belt 10 may have a release layer that facilitates release of the curable layer 12B on the surface (outer circumferential surface) thereof. Examples of materials for the release layer include fluorocarbon resins, silicone rubber, olefin resins (such as PP, PE, COP, and TMP), polypropylene glycol, oil-based monomers, and paraffin wax.

In this exemplary embodiment, because the curing device 18, described later, is disposed on the inner circumferential side of the transfer belt 10, it supplies a stimulus to the curable layer 12B through the transfer belt 10. That is, the transfer belt 10 functions to transmit the stimulus to the curable layer 12B. For example, if the stimulus is ultraviolet radiation or an electron beam, as described later, the transfer belt 10 functions to transmit ultraviolet radiation or an electron beam. If the stimulus is heat, the transfer belt 10 functions to transmit heat. The transfer belt 10 may be highly resistant to the stimulus.

For example, if the curing device 18 is an ultraviolet irradiation device, the transfer belt 10 may be highly transparent and resistant to ultraviolet radiation. For example, the transfer belt 10 may have an ultraviolet transmittance of 70% or more. An ultraviolet transmittance within this range may allow the ultraviolet radiation energy required for the curing reaction of the curable layer 12B to be efficiently supplied to the curable layer 12B. In addition, such an ultraviolet transmittance may avoid heat generation, ozone degradation, ultraviolet degradation, decreased stiffness, and coloration due to absorption of ultraviolet radiation by the transfer belt 10.

Examples of materials for the transfer belt 10 include ethylene-tetrafluoroethylene copolymer (ETFE) films, polyethylene terephthalate (PET) films, poly-4-methylpentene-1 (TPX) films, and polyolefin (such as PP, COP, and PE) films. These materials may be used as a single layer or a multilayer structure of different materials.

In this exemplary embodiment, the surface of the transfer belt 10 that contacts the curable layer 12B may have low surface free energy (γ_{T}). In particular, the surface free energy (γ_{T}) is preferably lower than the surface free energy (γ_{P}) of the surface of the recording medium P that contacts the curable layer 12B, more preferably satisfies the following condition:

γ_{P}−γ_{T}>10

For example, the surface free energy is determined by the following method.

Specifically, the surface free energy is calculated from the contact angles of water and diiodomethane by the Zisman method using a built-in program of a CAM-200 contact angle analyzer (available from KSV Instruments Ltd.).

The member on which the curable layer 12B is formed is not limited to the transfer belt 10, but may be any member on which the curable layer 12B can be formed and from which it can be released, for example, a transfer member such as a transfer drum.

A release-agent-layer forming device 24 that supplies a release agent 24A to the surface of the transfer belt 10 to form a release agent layer 24B on the surface of the transfer belt 10 is disposed on the outer circumferential side (in the FIGURE, to the side) of the transfer belt 10. Specifically, the release-agent-layer forming device 24 is disposed opposite the portion of the transfer belt 10 entrained around the tension roller 10A. The release-agent-layer forming device 24 supplies the release agent 24A to this portion of the transfer belt 10 to form the release agent layer 24B each time the series of supply, ejecting, and transfer steps is complete.

The release-agent-layer forming device 24 has the length thereof in the width direction of the transfer belt (direction perpendicular to the rotational direction of the transfer belt 10). The length in the width direction is larger than or equal to that of the ejection region (image formation region) on the transfer belt 10.

The release-agent-layer forming device 24 includes, for example, a housing 24C disposed upstream of a curable-layer forming device 12 and containing the release agent 24A, a supply roller 24D that is disposed in the housing 24C and that supplies the release agent 24A to the transfer belt 10, and a blade 24E that controls the thickness of the release agent layer 24B formed of the release agent layer 24B supplied to the transfer belt 10 by the supply roller 24D. The release-agent-layer forming device 24 may optionally include a heater (not shown) that melts the release agent 24A with heat.

The release-agent-layer forming device 24 may be configured such that the supply roller 24D continuously contacts the transfer belt 10 or is movable away from the transfer belt 10. The type of release-agent-layer forming device 24 is not limited to the above example, but may be a device based on a known coating process (such as bar coating, spray coating, inkjet coating, air knife coating, blade coating, or roller coating).

Examples of release agents 24A include silicone oils, fluorocarbon oils, hydrocarbon oils, polyalkylene glycols, fatty acid esters, phenyl ethers, and phosphoric acid esters, of which silicone oils, fluorocarbon oils, and polyalkylene glycols are preferred.

While the release agent layer 24B is formed on the surface of the transfer belt 10 in this exemplary embodiment, it may be omitted if the transfer belt 10 is formed of a material, such as ETFE, having good surface releasability.

The curable-layer forming device 12 is disposed downstream of the release-agent-layer forming device 24 in the rotational direction of the transfer belt 10 as an example of a forming unit that supplies an image-recording composition curable in response to a stimulus and containing an absorbent material, a curable material, and a viscocontroller to the surface of the transfer belt 10 to form the curable layer 12B.

Specifically, the curable-layer forming device 12 is disposed opposite the portion of the transfer belt 10 between the tension rollers 10A and 10B. The curable-layer forming device 12 supplies the image-recording composition to this portion of the transfer belt 10 to form the curable layer 12B.

The curable-layer forming device 12 has the length thereof in the width direction of the transfer belt 10 (direction perpendicular to the rotational direction of the transfer belt 10). The length in the width direction is larger than or equal to that of the ejection region (image formation region) on the transfer belt 10.

The curable-layer forming device 12 may be disposed on the outer circumferential side of (in the FIGURE, above) the transfer belt 10 above the tension roller 10A to form the curable layer 12B on the portion of the transfer belt 10 entrained around the tension roller 10A.

The curable-layer forming device 12 includes, for example, a housing 12C containing the image-recording composition, a supply roller 12D that is disposed in the housing 12C and that supplies the image-recording composition to the transfer belt 10, and a blade 12E that controls the thickness of the curable layer 12B formed of the image-recording composition supplied to the transfer belt 10 by the supply roller 12D.

The curable-layer forming device 12 may be configured such that the supply roller 12D continuously contacts the transfer belt 10 or is movable away from the transfer belt 10. The curable-layer forming device 12 may be configured such that the housing 12C is supplied with the image-recording composition from an independent solution supply system (not shown) to enable intermittent or continuous supply of the image-recording composition.

The type of curable-layer forming device 12 is not limited to the above example, but may be a device based on a known supply process (for example, a coating process such as die coating, bar coating, spray coating, inkjet coating, air knife coating, blade coating, roller coating, comma coating, or flow coating).

Inkjet recording heads 14 are disposed downstream of the curable-layer forming device 12 in the rotational direction of the transfer belt 10 on the outer circumferential side of (in the FIGURE, above) the transfer belt 10 as an example of image-forming units that form an image by ejecting inks (ink droplets) 14A onto the surface of the curable layer 12B formed by the curable-layer forming device 12. Specifically, the inkjet recording heads 14 are disposed opposite the flat portion (unbent portion) of the transfer belt 10 between the tension rollers 10A and 10B to form an image on this portion of the transfer belt 10 by ejecting the inks 14A.

The inkjet recording heads 14 include, for example, in sequence from upstream to downstream in the rotational direction of the transfer belt 10, an inkjet recording head 14K that ejects black ink droplets, an inkjet recording head 14C that ejects cyan ink droplets, an inkjet recording head 14M that ejects magenta ink droplets, and an inkjet recording head 14Y that ejects yellow ink droplets.

Specifically, the inkjet recording heads 14 are recording heads based on an inkjet system for ejecting ink droplets from nozzles, such as a piezoelectric or thermal inkjet system. The inkjet recording heads 14 are configured to eject ink droplets onto the surface of the curable layer 12B being moved relative to the inkjet recording heads 14.

The inkjet recording heads 14 have the length thereof in the width direction of the transfer belt 10 (direction perpendicular to the rotational direction of the transfer belt 10). The length in the width direction, namely, the ejection width, is larger than or equal to that of the ejection region (image formation region) on the transfer belt 10. That is, the inkjet recording heads 14 are configured to form one line in the width direction (main scan direction) of the ejection region (image formation region) without being moved relative to the transfer belt 10 in the width direction.

A controller determines the nozzles used and the ejection timing based on image information, and the inkjet recording heads 14 eject ink droplets to form an image based on the image information. The control of the inkjet recording heads 14 and the inks ejected by the inkjet recording heads 14 will be described later.

The type of inkjet recording head 14 is not limited to the above example, but may be any type that can form an image on the curable layer 12B. For example, the inkjet recording heads 14 may be scan inkjet recording heads that can form one line in the width direction (main scan direction) of the ejection region (image formation region) by ejecting inks while being moved relative to the transfer belt 10 in the width direction.

A heater 30 is disposed downstream of the inkjet recording heads 14 in the rotational direction of the transfer belt 10 as a temperature-increasing unit. The heater 30 illustrated in the FIGURE includes a heating roller, a heating belt (such as a metal heat transfer belt) that is heated by the heating roller, and a counter roller disposed opposite the transfer belt 10. Alternatively, as a temperature-increasing unit, the heater 30 may use induction heating (1H), halogen heating, electrothermal heating, radiant heat by laser irradiation, heating belt bonding, or backside heat transfer contact with a heating medium.

The heater 30 may be disposed at a position where it can increase the temperature of the curable layer 12B after the inks are ejected onto the curable layer 12B by the inkjet recording heads 14 and before the curable layer 12B is transferred to the recording medium by the transfer device, particularly on the inner circumferential side of the transfer belt 10.

A pressing device 16 that presses the curable layer 12B having the ink droplets 14A deposited thereon against the recording medium P and a platen 22 that keeps the recording medium P flat are disposed downstream of the inkjet recording heads 14 in the rotational direction of the transfer belt 10.

Specifically, the platen 22 is disposed opposite the bottom of the transfer belt 10 (the portion that moves away from the tension roller 16B to contact the tension roller 10C).

Specifically, the pressing device 16 includes the tension roller 16B around which the transfer belt 10 is entrained and a pressing roller 16A disposed opposite the tension roller 16B with the transfer belt 10 therebetween. In the pressing device 16, the pressing roller 16A presses the recording medium P against the tension roller 16B while the recording medium P is held between and transported by the transfer belt 10 and the pressing roller 16A. The recording medium P is then held between and transported by the bottom of the transfer belt 10 (the portion that moves away from the tension roller 16B to contact the tension roller 10C) and the platen 22.

In this way, the curable layer 12B on the surface of the transfer belt 10 is subjected to transfer, cure, and release in contact with the recording medium P in the transfer region from the position where the transfer belt 10 and the recording medium P are held between the pressing roller 16A and the tension roller 16B (hereinafter also referred to as “contact starting position”) to the position where they are held between the tension roller 10C and the platen 22 (hereinafter also referred to as “release position”).

The curing device 18 is disposed downstream of the pressing device 16 in the rotational direction of the transfer belt 10 on the inner circumferential side of the transfer belt 10 as an example of a transfer unit that transfers the curable layer 12B having an image formed thereon by the inkjet recording heads 14 to the recording medium P. The curing device 18 is configured to cure the curable layer 12B in contact with the recording medium P in the transfer region by applying a stimulus so that the curable layer 12B is transferred from the transfer belt 10 to the recording medium P.

The curing device 18 is not necessarily disposed on the inner circumferential side of the transfer belt 10, but may instead be disposed on the outer circumferential side of the transfer belt 10. In this case, the transfer belt 10 does not need to have the function of transferring a stimulus to the curable layer 12B. Instead, the recording medium P needs to have the function of transferring a stimulus to the curable layer 12B.

The type of curing device 18 is selected depending on the type of curable material contained in the image-recording composition used. For example, if the curable material is an ultraviolet-curable material curable by ultraviolet irradiation, the curing device 18 may be an ultraviolet irradiation device that irradiates the image-recording composition (curable layer 12B) with ultraviolet radiation.

If the curable material is an electron-beam-curable material curable by electron beam irradiation, the curing device 18 may be an electron beam irradiation device that irradiates the image-recording composition (curable layer 12B) with an electron beam.

If the curable material is a thermosetting material curable by applying heat, the curing device 18 may be a heat-applying device that applies heat to the image-recording composition (curable layer 12B).

Examples of ultraviolet irradiation devices include metal halide lamps, high-pressure mercury lamps, ultrahigh-pressure mercury lamps, deep-ultraviolet lamps, electrodeless mercury lamps capable of external excitation with microwaves, ultraviolet lasers, xenon lamps, and ultraviolet LEDs.

Examples of electron beam irradiation devices include the scanned type and the curtain type. The curtain type extracts thermoelectrons generated by a filament through a grid in a vacuum chamber, accelerates the thermoelectrons at high voltage (for example, 70 to 300 kV) to form an electron flow, and releases the electron flow through a window.

Examples of heat-applying devices include heaters such as halogen lamps, ceramic heaters, nichrome heaters, microwave heaters, infrared lamps, and induction heaters.

A removing device 20 that removes residual image-recording composition and release agent 24A from the surface of the transfer belt 10 is disposed downstream of the curing device 18 in the rotational direction of the transfer belt 10 on the outer circumferential side of the transfer belt 10. Specifically, the removing device 20 is disposed opposite the side of the transfer belt 10 (the portion that moves away from the tension roller 10C to contact the tension roller 10A).

The removing device 20 includes a removing member 20A that contacts the transfer belt 10 to scrape residual image-recording composition off the transfer belt 10. The removing member 20A is, for example, a flat rubber blade. The removing device 20 also includes a container 20B that stores the image-recording composition and release agent 24A scraped off by the removing member 20A. The container 20B is a box that is open on the side opposite the transfer belt 10. The container 20B functions as a receiving part that receives the image-recording composition and release agent 24A scraped off by the removing member 20A and falling therefrom.

Next, the image-forming operation according to this exemplary embodiment will be described.

In the image-forming apparatus 101 according to this exemplary embodiment, the transfer belt 10 is rotated, and the release-agent-layer forming device 24 forms the release agent layer 24B on the surface of the transfer belt 10. The curable-layer forming device 12 then supplies the image-recording composition to the surface of the release agent layer 24B to form the curable layer 12B.

The inkjet recording heads 14 eject the ink droplets 14A onto the surface of the curable layer 12B under control of the controller, described later, to record dots corresponding to the pixels of the image to be formed. The dots recorded by the deposited ink droplets 14A form an image region on the curable layer 12B.

In this exemplary embodiment, the region where dots are recorded by ejecting the ink droplets 14A onto the curable layer 12B is referred to as “image region.”

As a temperature-increasing unit, the heater 30 heats the transfer belt 10, which then increases the temperature of the curable layer 12B so that the viscocontroller increases the viscosity of the curable layer 12B.

The inkjet recording heads 14 eject the ink droplets onto the unbent region of the surface of the transfer belt 10 rotatably supported under tension. The heater 30 may be disposed at a position where it can heat the unbent region of the surface of the transfer belt 10 rotatably supported under constant tension so as to follow changes in speed due to thermal expansion of the transfer belt 10. That is, the inkjet recording heads 14 eject the ink droplets onto the curable layer 12B without sagging in the transfer belt 10.

The pressing roller 16A and the tension roller 16B hold and press the recording medium P and the transfer belt 10 together. The curable layer 12B on the surface of the transfer belt 10 then contacts the recording medium P (contact starting position). The contact of the curable layer 12B with both the transfer belt 10 and the recording medium P is maintained until it reaches the position between the tension roller 10C and the platen 22 (release position).

The curing device 18 supplies a stimulus to the curable layer 12B in contact with both the transfer belt 10 and the recording medium P through the transfer belt 10 to cure the curable layer 12B so that the curable layer 12B is transferred from the surface of the transfer belt 10 to the recording medium P.

The stimulus may be applied in an amount sufficient to completely cure the curable layer 12B. For example, if the stimulus is ultraviolet radiation, the integrated light intensity thereof may be 10 to 1,000 mJ/cm² for higher transfer efficiency and reduced heat generation.

To apply a sufficient amount of stimulus to cure the curable layer 12B so that it can be released from the transfer belt 10, an additional stimulus may be applied after the initial transfer and release to completely cure the curable layer 12B.

While the curing device 18 applies a stimulus to the curable layer 12B in contact with both the transfer belt 10 and the recording medium P through the transfer belt 10 to cure the curable layer 12B in this exemplary embodiment, the image-forming apparatus 101 may further include a curing device (not shown) that completely cures the curable layer 12B after it is transferred to the recording medium P.

The curable layer 12B released from the transfer belt 10 at the release position forms a cured resin layer (latent image layer) having an image region T formed by the ink droplets 14A on the recording medium P.

After the curable layer 12B is transferred to the recording medium P, the removing device 20 removes residual image-recording composition and release agent 24A and foreign matter from the surface of the transfer belt 10. In this way, the image-forming apparatus 101 according to this exemplary embodiment performs the image-forming operation.

### EXAMPLES

The present invention is further illustrated by the following non-limiting examples.

### Example 1

### Image-Recording Composition

Curable material (urethane prepolymer, M1600 from Toagosei Co., Ltd., molecular weight: 10,000) 10% by mass

Curable material (silicone-modified urethane, CN990 from Osaka Organic Chemical Industry Ltd., molecular weight: 25,000) 5% by mass

Viscocontroller (N-isopropylacrylamide with reactive group, NIPAM from Kohjin Co., Ltd.) 10% by mass

TMP-EOTAc (from Shin Nakamura Chemical Co., Ltd.) 40% by mass

The materials listed above are mixed together. To the mixture, 30% by mass of absorbent particles (sulfonic-acid-modified crosslinked sodium polyacrylate, AQUALIC CS7s from Nippon Shokubai Co., Ltd., particle size: 2.8 μm) are added. The mixture is stirred by ball milling for 48 hours. To the mixture, 5% by mass of an initiator (IC184 from Ciba Specialty Chemicals Inc.) is added to prepare an image-recording composition.

The viscosity measured by the procedure described above is 700 mPa·s.

### Image Recording Evaluations

An ETFE/PET laminated belt (110 μm in thickness) is attached to the inkjet image-recording apparatus illustrated in the FIGURE as an intermediate transfer belt (365 mm in width and 366 mm in diameter).

The image-recording composition prepared as above is continuously applied to the surface of the intermediate transfer belt by die coating to form a curable layer having a thickness of 33 μm. An ink (trade name IC6-CL32 from Seiko Epson Corporation) is ejected from an ejecting device onto the curable layer to print an image. The intermediate transfer belt is heated to 60° C. from the inner circumferential side thereof using a halogen heater as a temperature-increasing device. The curable layer is cured by ultraviolet irradiation for five seconds using an ultraviolet irradiation device (160 W halogen lamp) as a stimulus-applying device. The image is transferred and fixed to a recording medium (PET tack paper, trade name PET-C50 from Oji Tac Co., Ltd.) by roller pressing under a load of 1 kg.

The results of the measurements and evaluations of various properties shown below are summarized in Table 1.

### Viscosity

The curable layer (image-recording composition) heated using a halogen heater as above is sampled for viscosity measurement according to the procedure described above. Table 1 shows the viscosity after heating and the ratio of change in viscosity (viscosity after heating/viscosity before heating).

At the same time, the temperature at which the curable layer thickens (thickening transition temperature) is measured by the following procedure.

### Thickening Transition Temperature

The viscosity transition temperature is determined by measuring the viscosity of the curable layer (image-recording composition) having the ink deposited thereon at 25° C., at a predetermined temperature (at a shear rate of 100^{-1/s}), and at the heating temperatures of the intermediate transfer belt in the Examples and the Comparative Examples.

Thickness and in-Plane Variation

The thickness and in-plane variation of the curable layer cured by ultraviolet irradiation as above are measured by the procedure described above.

### Hardness

The D hardness of the curable layer cured by ultraviolet irradiation as above is measured by the following procedure.

### Procedure for Measuring D Hardness

The surface hardness of the curable layer cured by ultraviolet irradiation is measured using an Asker D hardness meter by directly placing a D hardness needle on the curable layer on the intermediate transfer belt.

### Water Resistance

A water droplet is dropped on the curable layer cured by ultraviolet irradiation as above using a syringe and is wiped off with waste after 60 seconds. The curable layer is visually inspected for residue condition (water resistance) and is evaluated according to the following criteria:

A: No trace of water is found on the wiped surface after 60 seconds.

B: Slight traces of water are found on the wiped surface after 60 seconds.

C: Traces of water are found after 60 seconds, and the surface eroded.

### Adhesion

The releasability (adhesion strength) of the curable layer cured by ultraviolet irradiation as above are measured by a cross-cut test using adhesive tape according to JIS (Japanese Industrial Standards) K 5400 (1994).

The recording medium having the curable layer cured and fixed thereon by ultraviolet irradiation as above is cut into a strip sample having a width of 25 mm. The tensile adhesion strength of the sample is measured by pinching ends of the recording medium and the curable layer on the same side and pulling them at a speed of 30 mm/min in opposite directions (pulling the recording medium to the recording medium side and the curable layer to the curable layer side).

### Bending Resistance

The recording medium having the curable layer cured and fixed thereon by ultraviolet irradiation as above is subjected to a test (180° crack test) in which the recording medium (PET tack paper) is bent through 180° together with the curable layer fixed thereon and is inspected for the condition of the curable layer after release. The curable layer is evaluated according to the following criteria:

A: The curable layer has a fold line but adheres firmly without cracking or peeling.

B: The curable layer has a fold line but is not peeling.

C: The curable layer is cracked at a fold line and is peeling irrecoverably.

### Transfer Properties

The transfer efficiency is calculated by measuring the mass of the curable layer transferred from the intermediate transfer belt to the recording medium based on the difference between the mass of the recording medium before the curable layer is transferred thereto and the mass of the recording medium after the curable layer is transferred thereto.

### Image Quality (Line Image Quality)

A line image like a fine line is formed as the image recorded as above and is inspected for line image quality. The line image quality is evaluated according to the following criteria:

A: The image has good reproducibility with a constant line width and no density decrease.

B: The image is slightly thin at some positions and shows a slight density decrease.

C: The image has poor reproducibility with breaks at some positions and a considerable density decrease.

### Image Quality (Density Variation)

An image having patch densities varying in 16 levels of grayscale is formed as the image recorded as above and is inspected for density variation. The density variation is evaluated according to the following criteria:

A: The image has stable density with a correlation coefficient between patch density and the amount of ink ejected of 0.90 or more.

B: The image has slightly unstable density with a correlation coefficient between patch density and the amount of ink ejected of 0.7 to less than 0.90.

C: The image has unstable density with a correlation coefficient between patch density and the amount of ink ejected of less than 0.7.

### Example 2

An image-recording composition is prepared by the procedure described in Example 1 except that the curable material (CN990) is replaced with 5% by mass of another curable material (dimethylsilicone-modified prepolymer having polyol side chain, UV3500 from Shin-Etsu Chemical Co., Ltd., molecular weight: 2,200); the viscocontroller (NIPAM) is replaced with 10% by mass of another viscocontroller (polyoxyethylene-polyoxypropylene-polyoxyethylene triblock copolymer, reactive group: triacrylate, Pluronic F127 from BASF); the absorbent particles (AQUALIC CS7s) are replaced with 30% by mass of other absorbent particles (polystyrene-butyl methacrylate-ethoxy phthalate methacrylate emulsion terpolymer particles, SBP136 from Mitsubishi Chemical Corporation, particle size: 3.8 μm).

The viscosity measured by the procedure described above is 1,200 mPa·s.

Measurements and evaluations of various properties are performed by the procedures described in the image recording evaluations of Example 1 except that the coating thickness of the image-recording composition applied to the intermediate transfer belt is changed to 25 μm, and the temperature to which the intermediate transfer belt is heated from the inner circumferential side thereof using a halogen heater is changed to 70° C. The results are summarized in Table 1.

### Example 3

An image-recording composition is prepared by the procedure described in Example 1 except that the curable material (CN990) is replaced with 5% by mass of another curable material (silicone-modified prepolymer, UV3570 from Shin-Etsu Chemical Co., Ltd., molecular weight: 3,000); the viscocontroller (NIPAM) is replaced with 5% by mass of another viscocontroller (thickening polysaccharide polymer, KELZAN from CP KELCO, reactive group: acrylate); and 5% by mass of phenoxy acrylate (POA) (from Toagosei Co., Ltd., SP=9.7) is added as a diluent.

The viscosity measured by the procedure described above is 640 mPa·s.

Measurements and evaluations of various properties are performed by the procedures described in the image recording evaluations of Example 1 except that the coating thickness of the image-recording composition applied to the intermediate transfer belt is changed to 18 μm, and the temperature to which the intermediate transfer belt is heated from the inner circumferential side thereof using a halogen heater is changed to 55° C. The results are summarized in Table 1.

### Example 4

An image-recording composition is prepared by the procedure described in Example 2 except that the viscocontroller (Pluronic F127) is replaced with 10% by mass of another viscocontroller (water-based polyurethane resin, APC-55 from Nicca Chemical Co., Ltd., reactive group: diacrylate).

The viscosity measured by the procedure described above is 1,140 mPa·s.

Measurements and evaluations of various properties are performed by the procedures described in the image recording evaluations of Example 1 except that the coating thickness of the image-recording composition applied to the intermediate transfer belt is changed to 24 μm, and the temperature to which the intermediate transfer belt is heated from the inner circumferential side thereof using a halogen heater is changed to 80° C. The results are summarized in Table 1.

### Comparative Example 1

An image-recording composition is prepared by the procedure described in Example 1 except that the viscocontroller (NIPAM) is not contained, and the content of TMP-EOTAc is changed from 40% by mass to 50% by mass.

The viscosity measured by the procedure described above is 1,100 mPa·s.

Measurements and evaluations of various properties are performed by the procedures described in the image recording evaluations of Example 1 except that the coating thickness of the image-recording composition applied to the intermediate transfer belt is changed to 20 μm, and the intermediate transfer belt is not heated using a halogen heater. The results are summarized in Table 1.

TABLE 1

| | | Example | Example | Example | Example | Comparative |
|---|---|---|---|---|---|---|
| | | 1 | 2 | 3 | 4 | Example 1 |
| Viscosity | Viscosity before heating | 700 | 1,200 | 640 | 1,140 | 1,100 |
| | (mPa · s) | | | | | |
| | Viscosity after heating | 2,300 | 3,000 | 3,500 | 5,000 | (1,200)*¹ |
| | (mPa · s) | | | | | |
| | Ratio of change in | 3.3 | 2.5 | 5.5 | 4.4 | 1.1 |
| | viscosity | | | | | |
| | Thickening transition | 56 | 70 | 55 | 80 | None |
| | temperature (° C.) | | | | | |
| Thickness | Coating thickness (μm) | 32 | 35 | 28 | 40 | 20 |
| | Thickness after cure | 23 | 25 | 18 | 24 | 27 |
| | (μm) | | | | | |
| | In-plane variation (%) | 5 | 7 | 2 | 3 | 1 |
| Hardness | D hardness | 88 | 93 | 68 | 78 | 98 |
| Water | Residue condition | A | A | A | A | B |
| resistance | | | | | | |
| Adhesion | Cross-cut test (number | 100 | 90 | 100 | 95 | 65 |
| | of squares remaining) | | | | | |
| | Tensile adhesion | 5.3 | 3.3 | 2.4 | 6.3 | 0.4 |
| | strength (N) | | | | | |
| Bending | Bending test | A | A | A | A | C |
| resistance | | | | | | |
| Transfer | Transfer efficiency (%) | 95% | 96% | 97% | 93% | 85% |
| properties | | | | | | |
| Image | Line image quality | A | A | A | A | B |
| quality | Density variation | A | A | A | A | B |

*¹Not heated (variation over time)

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image-recording composition comprising:
absorbent particles;
a curable material curable in response to ultraviolet radiation, an electron beam, or heat; and
a viscocontroller that increases the viscosity of the image-recording composition with increasing temperature.

2. The image-recording composition according to claim 1, wherein the curable material is curable in response to ultraviolet radiation.

3. The image-recording composition according to claim 1, wherein the viscocontroller has a reactive group in a molecule thereof.

4. The image-recording composition according to claim 2, wherein the viscocontroller has a reactive group in a molecule thereof.

5. The image-recording composition according to claim 1, wherein the curable material is a curable prepolymer.

6. The image-recording composition according to claim 2, wherein the curable material is a curable prepolymer.

7. The image-recording composition according to claim 3, wherein the curable material is a curable prepolymer.

8. The image-recording composition according to claim 4, wherein the curable material is a curable prepolymer.

9. The image-recording composition according to claim 1, wherein
the curable material is selected from the group consisting of urethane prepolymers, silicone-modified urethanes, dimethylsilicone-modified prepolymers having a polyol side chain, and silicone-modified prepolymers; and
the viscocontroller is selected from the group consisting of N-isopropylacrylamide, triacrylated polyoxyethylene-polyoxypropylene-polyoxyethylene triblock copolymers, thickening polysaccharide polymers, and diacrylated water-based polyurethane resins.

10. An image-recording apparatus comprising:
an intermediate transfer member;
a supply device that supplies the image-recording composition according to claim 1 to the intermediate transfer member to form a curable layer;
an ejecting device that ejects droplets containing an aqueous solvent onto the curable layer formed on the intermediate transfer member;
a transfer device that transfers the curable layer having the droplets deposited thereon from the intermediate transfer member to a recording medium;
a temperature-increasing device that increases the temperature of the curable layer after the droplets are ejected onto the curable layer by the ejecting device and before the curable layer is transferred to the recording medium by the transfer device; and
a stimulus-applying device that applies ultraviolet radiation, an electron beam, or heat to the curable layer.

11. The image-recording apparatus according to claim 10, wherein the temperature-increasing device increases the temperature of the curable layer on the intermediate transfer member by heating at least part of the intermediate transfer member to about 30° C. to about 100° C.

12. The image-recording apparatus according to claim 10, wherein the temperature-increasing device heats the intermediate transfer member from a surface of the intermediate transfer member opposite a surface on which the curable layer is formed.

13. The image-recording apparatus according to claim 11, wherein the temperature-increasing device heats the intermediate transfer member from a surface of the intermediate transfer member opposite a surface on which the curable layer is formed.

14. An image-recording method comprising:
supplying the image-recording composition according to claim 1 to an intermediate transfer member to form a curable layer;
ejecting droplets containing an aqueous solvent onto the curable layer formed on the intermediate transfer member;
transferring the curable layer having the droplets deposited thereon from the intermediate transfer member to a recording medium;
increasing the temperature of the curable layer after the droplets are ejected onto the curable layer in the ejecting and before the curable layer is transferred to the recording medium in the transfer; and
applying ultraviolet radiation, an electron beam, or heat to the curable layer.

15. The image-recording method according to claim 14, wherein the temperature of the curable layer on the intermediate transfer member is increased by heating at least part of the intermediate transfer member to about 30° C. to about 100° C. in the temperature increasing.

16. The image-recording method according to claim 14, wherein the intermediate transfer member is heated from a surface of the intermediate transfer member opposite a surface on which the curable layer is formed in the temperature increasing.

17. The image-recording method according to claim 15, wherein the intermediate transfer member is heated from a surface of the intermediate transfer member opposite a surface on which the curable layer is formed in the temperature increasing.
